(19) United States
(12) Patent Application Publication
(10) Pub. No.: US 2026/0131773 A1
(43) Pub. Date: May 14, 2026

(54) BRAKE SYSTEM AND METHOD OF CONTROLLING THE SAME

(71) Applicant: HL MANDO CORPORATION, Gyeonggi-do (KR)

(72) Inventor: Kwanseek KIM, Gyeonggi-do (KR)

(21) Appl. No.: 19/190,496

(22) Filed: Apr. 25, 2025

(30) Foreign Application Priority Data
Nov. 8, 2024 (KR) 10-2024-0157756

(51) Int. Cl. B60T 13/14; B60T 8/171; B60T 8/172; B60T 13/68

(52) U.S. Cl. CPC B60T 13/148; B60T 8/171; B60T 8/172; B60T 13/686; B60T 13/142; B60T 2270/402; B60T 2270/406; B60T 2270/413

(57) ABSTRACT

A brake system comprises: a hydraulic pressure supplier with a motor including first and second motor coils to pressurize a pressing medium for generating hydraulic pressure; a hydraulic controller positioned between the hydraulic pressure supplier and plurality of wheel cylinders, incorporating one or more valves with first and second valve coils to transmit generated hydraulic pressure to the wheels; and a control device including electrically isolated first and second controllers configured to perform first operation control on the hydraulic pressure supplier and hydraulic controller in normal state and second operation control in abnormal state, wherein control operations are based on at least one of the hydraulic pressure and a pedal displacement signal corresponding to brake pedal movement, thereby ensuring operational redundancy and fault tolerance in critical braking conditions.

### CROSS-REFERENCE TO RELATED APPLICATIONS

This application claims the priority of Korean Patent Application No. 10-2024-0157756 filed on Nov. 8, 2024, in the Korean Intellectual Property Office, the disclosure of which is incorporated herein by reference.

### BACKGROUND

### Field

The disclosed disclosure relates to a brake system and a method of controlling the same.

### Description of the Related Art

With the advancement of vehicle technologies and the increasing demand for safety of drivers and occupants, there is a need for more efficient, safer braking systems. A hydraulic brake system in the related art provides a predetermined level of braking performance by generating a braking force by converting an operating force of a brake pedal into hydraulic pressure. However, the hydraulic brake system has a limitation in terms of a reaction speed and accuracy and has a problem in that efficiency is degraded by complexity and weight of a hydraulic system.

An integrated dynamic brake (IDB) system developed to solve the above-mentioned problem electrohydraulically controls a braking force by converting the operating force of the brake pedal into an electrical signal. The IDB refers to an integrated electromechanical brake made by combining an electronic booster and electronic stability control (ESC). The IDB may more quickly and accurately brake the vehicle and easily distribute the braking force, thereby providing further improved stability and braking performance in comparison with the hydraulic system in the related art. In addition, the IDB may substitute for the hydraulic system, simplify the system, and reduce the weight, thereby providing a significant advantage even in terms of efficiency.

However, because many parts of an electronic control brake system, such as the IDB, are configured as electronic devices, there is always a risk of failure. A severe accident may occur when an electronic control unit (ECU) fails and the brake system does not operate while the vehicle travels. Therefore, it is necessary to prepare for an inoperability state of the brake system.

### SUMMARY

An object to be achieved by the present disclosure is to provide a brake system and a method of controlling the same, the brake system capable of entirely operating normally even if a part of the brake system fails.

One aspect of the disclosed disclosure provides a brake system including: a hydraulic pressure supplier including a motor configured to pressurize a pressing medium, in which the hydraulic pressure supplier is configured to generate hydraulic pressure; a hydraulic controller provided between the hydraulic pressure supplier and a plurality of wheel cylinders respectively provided in wheels of a vehicle, in which the hydraulic controller includes one or more valves and is configured to transmit the hydraulic pressure, which is generated by the hydraulic pressure supplier, to the plurality of wheel cylinders; and a control device configured to control at least one of the hydraulic pressure supplier and the hydraulic controller, based on at least one of the hydraulic pressure and a pedal displacement signal corresponding to a movement of a brake pedal, in which the motor includes a first motor coil and a second motor coil, in which the valve includes a first valve coil and a second valve coil, in which the control device includes a first controller and a second controller configured to perform a first operation control on the hydraulic pressure supplier and the hydraulic controller in a normal state and perform a second operation control on the hydraulic pressure supplier and the hydraulic controller in an abnormal state, and in which the first controller and the second controller are electrically isolated from each other and perform the first operation control or the second operation control on the hydraulic pressure supplier and the hydraulic controller.

The first controller may include: a first motor driver configured to control a power supply to the first motor coil of the motor; a first valve driver configured to control a power supply to the first valve coil of the valve; a first processor configured to control the first motor driver and the first valve driver; and a first regulator configured to provide at least one of the first valve driver and the first processor with first driving power at a preset level, and the second controller may include: a second motor driver configured to control a power supply to the second motor coil of the motor; a second valve driver configured to control a power supply to the second valve coil of the valve; a second processor configured to control the second motor driver and the second valve driver; and a second regulator configured to provide at least one of the second valve driver and the second processor with second driving power at a preset level.

The first valve coil and the second valve coil of the valve may be disposed in series by being wound around an outer peripheral surface of a bobbin in one axial direction.

The first valve coil and the second valve coil may be alternately and sequentially wound around the outer peripheral surface of the bobbin.

The valve may further include: a first valve coil terminal connected to two opposite ends of the first valve coil; and a second valve coil terminal connected to two opposite ends of the second valve coil.

The first valve coil terminal and the second valve coil terminal may be disposed symmetrically with respect to the bobbin.

The two opposite ends of the first valve coil and the two opposite ends of the second valve coil may penetrate an upper portion of a coil casing configured to accommodate the first valve coil and the second valve coil and be connected to the first valve coil terminal and the second valve coil terminal provided on the upper portion of the coil casing.

A first exposure region between the two opposite ends of the first valve coil and the coil casing and a second exposure region between the two opposite ends of the second valve coil and the coil casing may be provided to be accommodated in a separate insulator.

The first valve coil terminal may be configured to be electrically connected to the first valve driver, and the second valve coil terminal may be configured to be electrically connected to the second valve driver.

The first valve coil and the second valve coil may be provided as solenoid coils.

The brake system may further include: an internal communication network configured to connect the first controller and the second controller, in which the first controller and the second controller identify states thereof by means of the internal communication network.

The first operation control may perform cooperative control by allowing the first processor to control the first motor driver and the first valve driver and allowing the second processor to control the second motor driver and the second valve driver when the first controller and the second controller are identified as being in the normal states.

When a failure of any one of the first controller and the second controller is identified, the second operation control may allow the other of the first controller and the second controller to control a power supply to the first valve coil based on control of the first valve driver or control a power supply to the second valve coil based on control of the second valve driver.

The brake system may further include: a power supply device configured to supply power to the control device, in which the power supply device includes: a first power supplier configured to supply first power to the first controller; and a second power supplier configured to supply second power to the second controller.

The first power supplier and the second power supplier may respectively output the first power and the second power at different levels.

Another aspect of the disclosed disclosure provides a method of controlling a brake system, which includes a hydraulic pressure supplier including a motor including a first motor coil and a second motor coil and configured to generate hydraulic pressure, a hydraulic controller including a valve including a first valve coil and a second valve coil and configured to transmit the hydraulic pressure, which is generated by the hydraulic pressure supplier, to a plurality of wheel cylinders, and a first controller and a second controller isolated electrically and configured to perform a first operation control or a second operation control on the hydraulic pressure supplier and the hydraulic controller, the method including: performing, by the first controller and the second controller, the first operation control on the hydraulic pressure supplier and the hydraulic controller in a normal state and performing the second operation control on the hydraulic pressure supplier and the hydraulic controller in an abnormal state based on at least one of the hydraulic pressure and a pedal displacement signal corresponding to a movement of a brake pedal.

The method may further include: identifying states of the first controller and the second controller; and performing cooperative control by allowing a first processor of the first controller to control a first motor driver and a first valve driver and allowing a second processor of the second controller to control a second motor driver and a second valve driver based on the first operation control when the first controller and the second controller are identified as being in the normal states.

The method may further include: identifying states of the first controller and the second controller; and controlling, by a first processor of the first controller, a first motor driver and a first valve driver and controlling, by the first valve driver, a power supply to a first valve coil of the valve based on the second operation control when a failure of the second controller is identified.

The method may further include: controlling, by a second processor of the second controller, a second motor driver and a second valve driver and controlling, by the second valve driver, a power supply to a second valve coil of the valve based on the second operation control when a failure of the first controller is identified.

The brake system may further include: a first power supplier configured to provide first power to the first controller; and a second power supplier configured to provide second power to the second controller, and the method may further include providing, by the first power supplier and the second power supplier, the first controller and the second controller with the first power and the second power at different levels.

One aspect of the disclosed disclosure may provide the brake system and the method of controlling the same, the brake system capable of entirely operating normally even if a part of the brake system fails.

Therefore, the brake system and the method of controlling the same may ensure the redundancy capable of coping with the failure of some devices and prevent an increase in costs and an addition of processes due to the addition of other devices.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a brake system according to an embodiment of the disclosed disclosure and a configuration of a vehicle related to the brake system.

FIG. 2 is a view illustrating a structure of a hydraulic pressure device included in the brake system according to the embodiment of the disclosed disclosure.

FIG. 3 is a view illustrating a connection relationship of a control device according to the embodiment of the disclosed disclosure.

FIG. 4 is a view illustrating a cross-sectional structure of a valve according to the embodiment of the disclosed disclosure.

FIG. 5 is a view illustrating a planar structure of the valve according to the embodiment of the disclosed disclosure.

FIG. 6 is a view illustrating a connection relationship between the valve and a valve driver according to the embodiment of the disclosed disclosure.

FIG. 7 is a view illustrating a method of controlling the brake system according to the embodiment of the disclosed disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

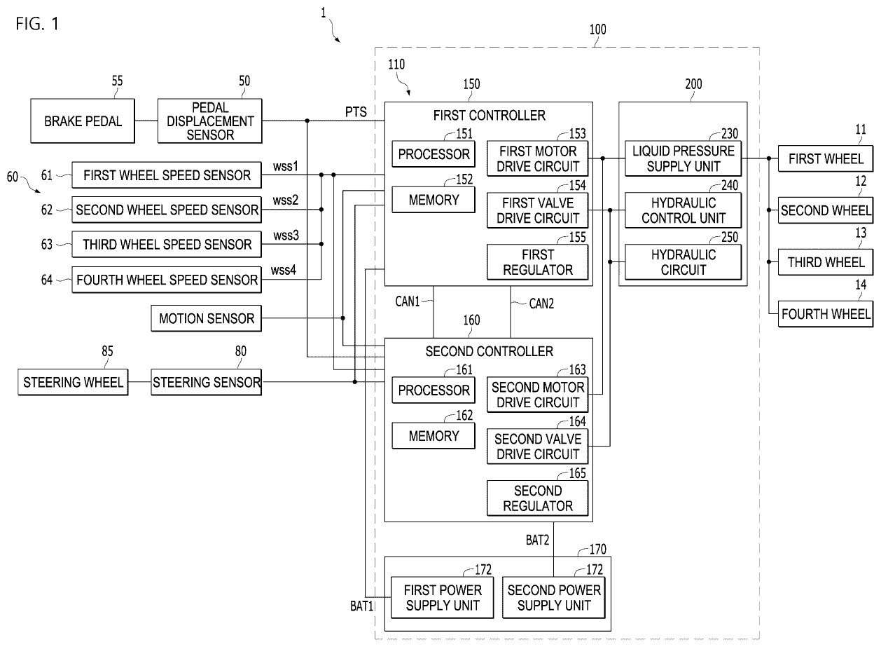

FIG. 1 is a view illustrating a brake system according to an embodiment of the disclosed disclosure and a configuration of a vehicle related to the brake system.

With reference to FIG. 1, a vehicle 1 may include a plurality of wheels 11, 12, 13, and 14 configured to rotate to move the vehicle 1, a brake pedal 55 configured to acquire an input related to braking from a driver, a pedal displacement sensor 50 configured to detect a movement of the brake pedal 55, a wheel speed sensor 60 configured to detect rotational speeds of the plurality of wheels 11, 12, 13, and 14, a motion sensor 70 configured to detect a motion of the vehicle 1, a steering sensor 80 configured to detect a rotation of a steering wheel 85, a brake system 100 configured to provide a braking force to the plurality of wheels 11, 12, 13, and 14 to stop the vehicle, and a power supply device 170 configured to supply power to the brake system 100 and the like. The pedal displacement sensor 50, the wheel speed sensor 60, the motion sensor 70, and/or the steering sensor 80 are not essential components, and all or at least some of the above-mentioned components may be excluded.

For example, the plurality of wheels 11, 12, 13, and 14 may include a first wheel 11 provided at a front left side of the vehicle 1, a second wheel 12 provided at a front right side of the vehicle 1, a third wheel 13 provided at a rear left side of the vehicle 1, and/or a fourth wheel 14 provided at a rear right side of the vehicle 1. However, the number of wheels 11, 12, 13, and 14 is not limited to four.

For example, the brake pedal 55 may be provided at a lower side of a cabin so that the driver may control the brake pedal 55 with his/her foot. The driver may push the brake pedal 55 in accordance with a braking intention to brake the vehicle 1. In accordance with the driver's braking intention, the brake pedal 55 may depart from a reference position and move.

The pedal displacement sensor 50 may be installed in the vicinity of the brake pedal 55 and measure the movement of the brake pedal 55 made by the driver's braking intention. For example, the pedal displacement sensor 50 may detect a movement distance and/or a movement speed of the brake pedal 55 from a reference position.

The pedal displacement sensor 50 may be electrically connected to the brake system 100 and provide an electrical signal to the brake system 100. For example, the pedal displacement sensor 50 may be connected directly to the brake system 100 through a hard wire or connected to the brake system 100 through a communication network. In addition, the pedal displacement sensor 50 may provide the brake system 100 with an electrical signal corresponding to the movement distance and/or the movement speed of the brake pedal 55. In addition, the pedal displacement sensor 50 may be integrated with the brake system 100.

The brake system 100 may include a hydraulic pressure device 200 configured to generate hydraulic pressure for braking the vehicle 1, and a control device 110 configured to control an operation of the hydraulic pressure device 200.

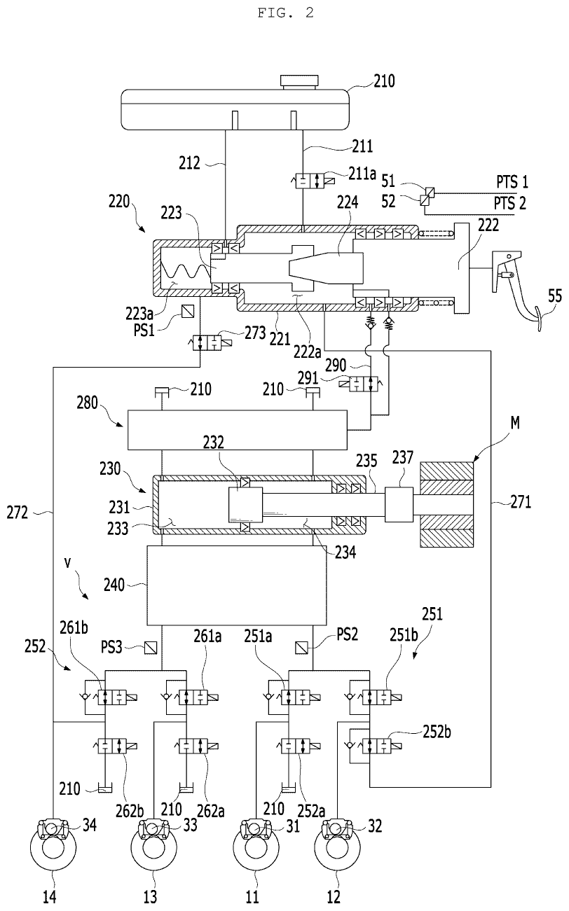

The hydraulic pressure device 200 may provide hydraulic pressure for applying the braking force to a plurality of wheel cylinders (31, 32, 33, and 34 in FIG. 2) provided in the plurality of wheels 11, 12, 13, and 14. For example, the hydraulic pressure device 200 may detect the driver's braking intention by means of a brake pedal 55. The hydraulic pressure device 200 may generate the hydraulic pressure based on a movement distance and/or a movement speed of the brake pedal 55 and provide the generated hydraulic pressure to the plurality of wheel cylinders (31, 32, 33, and 34 in FIG. 2) respectively provided in the wheels 11, 12, 13, and 14.

The internal pressure of the plurality of wheel cylinders (31, 32, 33, and 34 in FIG. 2) may depend on the hydraulic pressure provided by the hydraulic pressure device 200. The braking forces may be applied to the wheels 11, 12, 13, and 14 depending on the internal pressure of the plurality of wheel cylinders 31, 32, 33, and 34.

FIG. 2 is a view illustrating a structure of the hydraulic pressure device included in the brake system according to the embodiment of the disclosed disclosure.

With reference to FIG. 2, the hydraulic pressure device 200 may include a reservoir 210 configured to store a pressing medium, a master cylinder 220 configured to provide the driver with a reaction force corresponding to a pedal effort of the brake pedal 55 and pressurize and discharge the pressing medium such as brake oil accommodated therein, a hydraulic pressure supplier 230 configured to generate hydraulic pressure of the pressing medium by means of a mechanical operation by receiving the driver's braking intention as an electrical signal from the pedal displacement sensor 50 configured to detect a displacement of the brake pedal 55, a hydraulic controller 240 configured to control the hydraulic pressure provided from the hydraulic pressure supplier 230, a hydraulic circuit 250 having wheel cylinders 31 and 32 configured to brake the wheels 11, 12, 13, and 14 by receiving the hydraulic pressure of the pressing medium, a backup flow path 271 configured to hydraulically connect the master cylinder 220 and the hydraulic circuit 250, a dump control unit 280 provided between the hydraulic pressure supplier 230 and the reservoir 210 and configured to control a flow of the pressing medium, reservoir flow paths 211 and 212 configured to hydraulically connect the reservoir 210 and the master cylinder 220, and an inspection flow path 290 connected to a master chamber of the master cylinder 220.

The reservoir 210, the master cylinder 220, the hydraulic pressure supplier 230, the hydraulic controller 240, the hydraulic circuit 250, the backup flow path 271, the dump control unit 280, the reservoir flow paths 211 and 212, and the inspection flow path 290 are not essential components and all or at least some of the above-mentioned components may be excluded.

The reservoir 210 may accommodate and/or store the pressing medium therein. The reservoir 210 may be connected to the master cylinder 220, the hydraulic pressure supplier 230, and/or the hydraulic circuit 250 and supply or receive the pressing medium.

The reservoir flow paths 211 and 212 may include a first reservoir flow path 211 configured to connect a first master chamber 222a of the master cylinder 220 and the reservoir 210, and a second reservoir flow path 212 configured to connect a second master chamber 223a of the master cylinder 220 and the reservoir 210. A simulator valve 211a may be provided in the first reservoir flow path 211 and control the flow of the pressing medium between the reservoir 210 and the first master chamber 222a through the first reservoir flow path 211.

In case that the driver applies a pedal effort to the brake pedal 55 to perform the braking operation, the master cylinder 220 may provide stable pedal feel by providing the driver with a reaction force corresponding to the pedal effort. In addition, the master cylinder 220 may be configured to pressurize and discharge the pressing medium accommodated therein by the operation of the brake pedal 55.

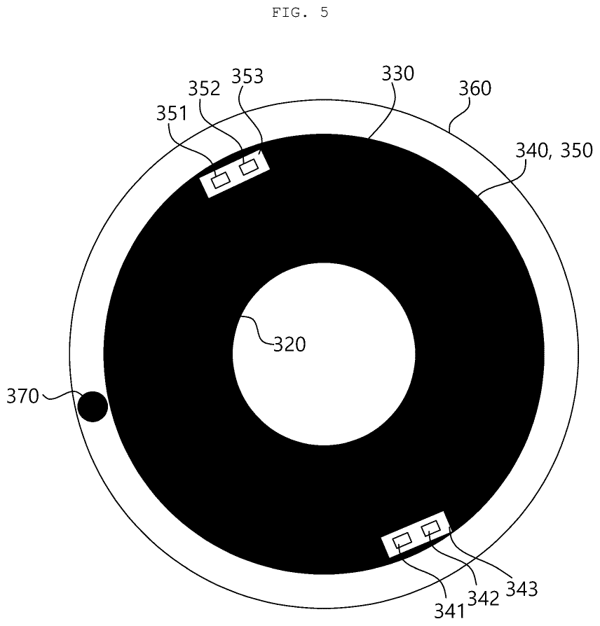

The master cylinder 220 may include a cylinder body 221 configured to define a chamber therein, the first master chamber 222a formed at an inlet side of the cylinder body 221 to which the brake pedal 55 is connected, a first master piston 222 provided in the first master chamber 222a, connected to the brake pedal 55, and configured to be displaced by the operation of the brake pedal 55, the second master chamber 223a formed on the cylinder body 221 and formed inward or forward (leftward based on FIG. 4) of the first master chamber 222a, a second master piston 223 provided in the second master chamber 223a and configured to be displaced by the displacement of the first master piston 222 or the hydraulic pressure of the pressing medium accommodated in the first master chamber 222a, and a pedal simulator 224 disposed between the first master piston 222 and the second master piston 223 and configured to provide pedal feel by means of an elastic restoring force generated by compression.

The cylinder body 221, the first master chamber 222a, the first master piston 222, the second master chamber 223a, the second master piston 223, and the pedal simulator 224 are not essential components, and all or at least some of the above-mentioned components may be excluded.

The first master piston 222 and the second master piston 223 may be respectively provided in the first master chamber 222a and the second master chamber 223a and form hydraulic pressure or negative pressure in the pressing medium accommodated in the chambers while moving forward and rearward.

The pedal simulator 224 may be provided between the first master piston 222 and the second master piston 223 and provide the pedal feel of the brake pedal 55 to the driver by the elastic restoring force thereof.

The hydraulic pressure supplier 230 may be configured to generate the hydraulic pressure of the pressing medium by the mechanical operation by receiving the driver's braking intention as an electrical signal from the pedal displacement sensor 50 configured to detect the displacement of the brake pedal 55.

The hydraulic pressure supplier 230 may include a cylinder block 231 configured to accommodate the pressing medium, a hydraulic piston 232 accommodated in the cylinder block 231, pressure chambers 233 and 234 separated by the hydraulic piston 232 and the cylinder block 231, a hydraulic pressure generation motor 236 configured to generate a rotational force, a power conversion unit 237 configured to convert the rotational force of the hydraulic pressure generation motor 236 into a translational movement of the hydraulic piston 232, and a driving shaft 235 configured to transmit power to the hydraulic piston 232.

The cylinder block 231, the hydraulic piston 232, the pressure chambers 233 and 234, the hydraulic pressure generation motor 236, the power conversion unit 237, and the driving shaft 235 are not essential components of the hydraulic pressure supplier 230, and at least some of the above-mentioned components may be excluded.

The pressure chambers 233 and 234 may include the first pressure chamber 233 positioned forward of the hydraulic piston 232 (leftward of the hydraulic piston 232 based on FIG. 2), and the second pressure chamber 234 positioned rearward of the hydraulic piston 232 (rightward of the hydraulic piston 232 based on FIG. 2). That is, the first pressure chamber 233 may be provided and defined by the cylinder block 231 and a front surface of the hydraulic piston 232, and a volume of the first pressure chamber 233 may change as the hydraulic piston 232 moves. In addition, the second pressure chamber 234 may be provided and defined by the cylinder block 231 and a rear surface of the hydraulic piston 232, and a volume of the second pressure chamber 234 may change as the hydraulic piston 232 moves.

When the pedal displacement sensor 50 detects the displacement of the brake pedal 55, the hydraulic piston 232 may generate the hydraulic pressure in the first pressure chamber 233 and generate the negative pressure in the second pressure chamber 234 while moving forward in the cylinder block 231. On the contrary, when the pedal effort of the brake pedal 55 is eliminated, the hydraulic piston 232 may generate the negative pressure in the first pressure chamber 233 and generate the hydraulic pressure in the second pressure chamber 234 while moving rearward in the cylinder block 231.

As described above, the hydraulic pressure generation motor 236 of the hydraulic pressure supplier 230 may generate the hydraulic pressure or the negative pressure in each of the first pressure chamber 233 and the second pressure chamber 234.

The hydraulic pressure supplier 230 may be hydraulically connected to the reservoir 210 by the dump control unit 280. The dump control unit 280 may include at least one flow path and one or more valves to control the flow of the pressing medium between the hydraulic pressure supplier 230 and the reservoir 210.

The hydraulic controller 240 may be configured to control the hydraulic pressure to be transmitted to the wheel cylinders 31, 32, 33, and 34.

The hydraulic controller 240 may be connected to a first hydraulic circuit 251 and a second hydraulic circuit 252 configured to control the flow of the hydraulic pressure to be transmitted to the first to fourth wheels cylinders 31, 32, 33, and 34.

The hydraulic controller 240 may include a plurality of flow paths and a plurality of valves to guide the hydraulic pressure, which is supplied from the hydraulic pressure supplier 230, to the first hydraulic circuit 251 and the second hydraulic circuit 252.

The hydraulic controller 240 may define a flow path for providing the pressing medium to the first hydraulic circuit 251 and the second hydraulic circuit 252 by using the pressure in the first pressure chamber 233 generated by the forward movement of the hydraulic piston 232. For example, the hydraulic controller 240 may define a flow path configured to connect the first pressure chamber 233 and the first hydraulic circuit 251 and the second hydraulic circuit 252. The pressing medium in the first pressure chamber 233 may be provided to the first hydraulic circuit 251 and the second hydraulic circuit 252 by means of the hydraulic controller 240.

The hydraulic controller 240 may define a flow path for providing the pressing medium to the first hydraulic circuit 251 and the second hydraulic circuit 252 by using the pressure in the second pressure chamber 234 generated by the rearward movement of the hydraulic piston 232. For example, the hydraulic controller 240 may define a flow path configured to connect the second pressure chamber 234 and the first hydraulic circuit 251 and the second hydraulic circuit 252. The pressing medium in the second pressure chamber 234 may be provided to the first hydraulic circuit 251 and the second hydraulic circuit 252 by means of the hydraulic controller 240.

The hydraulic controller 240 may define a flow path for recovering the pressing medium from the first hydraulic circuit 251 and the second hydraulic circuit 252 by using the negative pressure in the first pressure chamber 233 generated by the rearward movement of the hydraulic piston 232. For example, the hydraulic controller 240 may define a flow path configured to connect a first hydraulic circuit 251 and the first pressure chamber 233 and connect a second hydraulic circuit 252 and the first pressure chamber 233. The pressing medium in the first hydraulic circuit 251 and the second hydraulic circuit 252 may be provided to the first pressure chamber 233 through the hydraulic controller 240.

The hydraulic controller 240 may define a flow path for recovering the pressing medium from the first hydraulic circuit 251 and the second hydraulic circuit 252 by using the negative pressure in the second pressure chamber 234 generated by the forward movement of the hydraulic piston 232. For example, the hydraulic controller 240 may define a flow path configured to connect the first hydraulic circuit 251 and the second pressure chamber 234 and connect the second hydraulic circuit 252 and the second pressure chamber 234. The pressing medium in the first hydraulic circuit 251 and the second hydraulic circuit 252 may be provided to the second pressure chamber 234 through the hydraulic controller 240.

The first hydraulic circuit 251 may adjust and/or control the hydraulic pressure to be applied to the first and second wheel cylinders 31 and 32, and the second hydraulic circuit 252 may adjust and/or control the hydraulic pressure to be applied to the third and fourth wheel cylinders 33 and 34.

The first hydraulic circuit 251 may have first and second inlet valves 251a and 251b respectively disposed at upstream sides of the first and second wheel cylinders 31 and 32 and configured to control a flow of the pressing medium and the hydraulic pressure to be transmitted to the first and second wheel cylinders 31 and 32. The first and second inlet valves 251a and 251b may each be provided as a normal open-type solenoid valve.

In addition, the first hydraulic circuit 251 may include first and second outlet valves 252a and 252b configured to control a flow of the pressing medium discharged from the first and second wheel cylinders 31 and 32 in order to improve performance when the first and second wheel cylinders 31 and 32 perform braking release operations.

The first outlet valve 252a may be disposed at a discharge side of the first wheel cylinder 31 and control a flow of the pressing medium to be transmitted from the first wheel cylinder 31 to the reservoir 210. The first outlet valve 252a may be provided as a normal closed-type solenoid valve.

The second outlet valve 252b may be connected to (or provided in) a first backup flow path 271 corresponding to a discharge side of the second wheel cylinder 32 and control a flow of the pressing medium between the second wheel cylinder 32 and the master cylinder 220. However, the connection structure of the first backup flow path 271 is not limited thereto. For example, the first backup flow path 271 may be connected to the first wheel cylinder 31. In addition, the first backup flow path 271 may be connected to the first wheel cylinder 31 and the second wheel cylinder 32. As described above, the first backup flow path 271 may be connected to at least one of the first wheel cylinder 31 and the second wheel cylinder 32. The second outlet valve 252b may be provided as a normal open-type solenoid valve.

The second hydraulic circuit 252 may have third and fourth inlet valves 261a and 261b respectively disposed at upstream sides of the third and fourth wheel cylinders 33 and 34 and configured to control a flow of the pressing medium and the hydraulic pressure to be transmitted to the third and fourth wheel cylinders 33 and 34. The third and fourth inlet valves 261a and 261b may each be provided as a normal open-type solenoid valve.

In addition, the second hydraulic circuit 252 may include third and fourth outlet valves 262a and 262b configured to control a flow of the pressing medium discharged from the third and fourth wheel cylinders 33 and 34 in order to improve performance when the third and fourth wheel cylinders 33 and 34 perform braking release operations.

The third outlet valve 262a may be provided at a discharge side of the third wheel cylinder 33 and control a flow of the pressing medium to be transmitted from the third wheel cylinder 33 to the reservoir 210. The third outlet valve 262a may be provided as a normal closed-type solenoid valve.

The fourth outlet valve 262b may be provided at a discharge side of the fourth wheel cylinder 34 and control a flow of the pressing medium to be transmitted from the fourth wheel cylinder 34 to the reservoir 210. The fourth outlet valve 262b may be provided as a normal closed type solenoid valve.

A cut valve 273 may be provided in a second backup flow path 272 corresponding to a discharge side of the fourth wheel cylinder 34 and control a flow of the pressing medium between the fourth wheel cylinder 34 and the master cylinder 220.

However, the connection structure of the second backup flow path 272 is not limited thereto. For example, the second backup flow path 272 may be connected to the third wheel cylinder 33. In addition, the second backup flow path 272 may be connected to the third wheel cylinder 33 and the fourth wheel cylinder 34. As described above, the second backup flow path 272 may be connected to at least one of the third wheel cylinder 33 and the fourth wheel cylinder 34.

In case that the brake module cannot normally operate because of a failure or the like, at least one of the first backup flow path 271 and the second backup flow path 272 may be configured to transmit the hydraulic pressure in the master cylinder 220 directly to the wheel cylinders 31, 32, 33, and 34 in an abnormal operating mode, i.e., a fallback mode. For example, the first backup flow path 271 may be provided to connect the first master chamber 222a of the master cylinder 220 and the first hydraulic circuit 251, and the second backup flow path 272 may be provided to connect the second master chamber 223a of the master cylinder 220 and the second hydraulic circuit 252.

The inspection flow path 290 may be provided to connect the master cylinder 220 and the dump control unit 280 and provided to inspect whether the simulator valve 211a and various types of component elements mounted in the master cylinder 220 leak.

The hydraulic pressure device 200 may include a first pressure sensor PS1 configured to measure the hydraulic pressure provided by the master cylinder 220, and second and third pressure sensors PS2 and PS3 configured to measure the hydraulic pressure of the pressing medium provided by the hydraulic pressure supplier 230. The first pressure sensor PS1, the second pressure sensor PS2, and the third pressure sensor PS3 may output electrical signals representing the measured pressure.

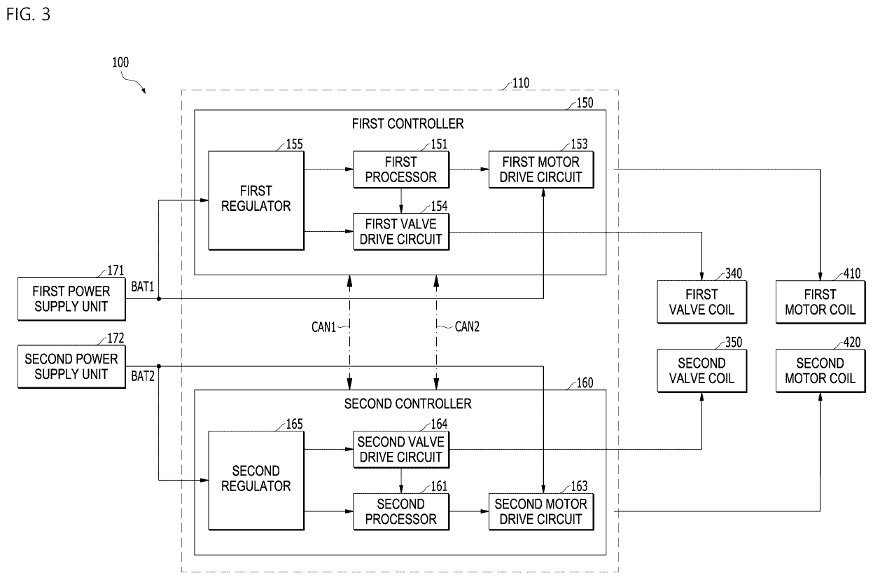

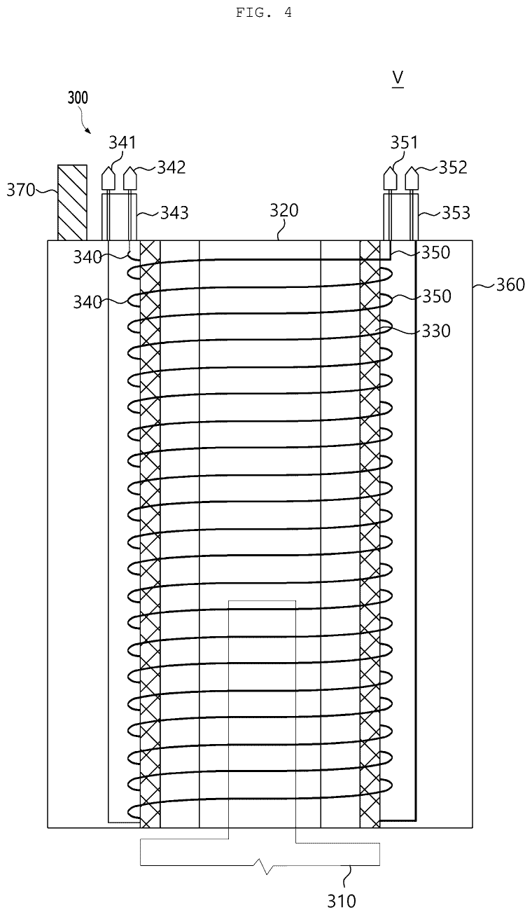

FIG. 3 is a view illustrating a connection relationship of the control device according to the embodiment of the disclosed disclosure.

With reference to FIGS. 1 and 3, the control device 110 may control at least one of the hydraulic pressure supplier 230 and the hydraulic controller 240 in response to at least one of a pedal displacement signal PTS, which corresponds to a movement of the brake pedal 55, and the hydraulic pressure generated by the hydraulic pressure device 200.

Specifically, the control device 110 may include a first controller and a second controller 150 and 160 configured to control the operation of the hydraulic pressure device 200.

The first controller 150 and the second controller 160 may receive output signals from the pedal displacement sensor 50, the wheel speed sensor 60, the motion sensor 70, and/or the steering sensor 80 and perform the braking control related to the plurality of wheel cylinders 110, 120, 130, and 140 in response to the received signals.

The first controller 150 and the second controller 160 may provide control signals to the hydraulic pressure device 200 to brake the vehicle 1 in response to at least one of the electrical signal outputted from the pedal displacement sensor 50 and the electrical signal outputted from the wheel speed sensor 60. For example, the first controller 150 and the second controller 160 may identify a braking force (or braking acceleration) for braking the vehicle 1 in response to the output signal from the pedal displacement sensor 50 and provide the hydraulic pressure device 200 with the control signal corresponding to the identified braking force (or braking acceleration).

The first controller 150 and the second controller 160 may provide the control signal to at least one of the hydraulic pressure supplier 230 and the hydraulic controller 240 to temporarily allow the rotations of the plurality of wheels 11, 12, 13, and 14 in response to the electrical signal outputted from the wheel speed sensor 60. For example, the first controller 150 and the second controller 160 may identify slips of all or some of the plurality of wheels 11, 12, 13, and 14 in response to the output signal from the wheel speed sensor 60 while the vehicle 1 is braked. The first controller 150 and the second controller 160 may provide the hydraulic controller 240 with the control signal that temporarily allows the rotations of the plurality of wheels 11, 12, 13, and 14 in order to eliminate the slips of the plurality of wheels 11, 12, 13, and 14 in response to the slips of the plurality of wheels 11, 12, 13, and 14. In this regard, the brake system 100 may perform an anti-lock braking system (ABS) function.

The first controller 150 and the second controller 160 may provide the control signal to at least one of the hydraulic pressure supplier 230 and the hydraulic controller 240 to temporarily brake the plurality of wheels 11, 12, 13, and 14 in response to the electrical signal outputted from the wheel speed sensor 60 without the user's braking intention. For example, the first controller 150 and the second controller 160 may identify spins of the plurality of wheels 11, 12, 13, and 14 in response to the output signal from the wheel speed sensor 60 while the vehicle 1 travels. The first controller 150 and the second controller 160 may provide the hydraulic controller 240 with the braking control signal that temporarily brakes the plurality of wheels 11, 12, 13, and 14 in order to eliminate the spins of the plurality of wheels 11, 12, 13, and 14 in response to the spins of the plurality of wheels 11, 12, 13, and 14. In this regard, the brake system 100 may perform a traction control system (TCS) function.

The first controller 150 and the second controller 160 may provide the braking control signal to the hydraulic pressure device 200 in order to temporarily brake the plurality of wheels 11, 12, 13, and 14 in response to the electrical signal outputted from the motion sensor 70 and/or the steering sensor 80 without the user's braking intention. For example, the first controller 150 and the second controller 160 may identify a reference route (reference rotation traveling route) for the vehicle 1 in response to an output signal from the steering sensor 80 while the vehicle 1 is steered, and the first controller 150 may identify a traveling route (rotation traveling route) of the vehicle 1 in response to an output signal of the motion sensor 70 while the vehicle 1 is steered. The first controller 150 and the second controller 160 may identify oversteering or understeering of the vehicle 1 based on the reference route and the traveling route. The first controller 150 may provide the hydraulic pressure device 200 with the braking control signal for temporarily braking the plurality of wheels 11, 12, 13, and 14 based on the oversteering and/or the understeering. In this regard, the brake system 100 may perform an electronic stability control (ESC) function.

The first controller 150 and the second controller 160 may include a plurality of semiconductor elements and be called various terms such as a brake control unit (BCU) and an electronic control unit (ECU). For example, the first controller 150 and the second controller 160 may each include at least one processor 151 or 161 and/or at least one memory 152 or 162.

In more detail, the first controller 150 may include a first motor driver 153 configured to control a power supply to a first motor coil 410 of a hydraulic pressure generation motor M, a first valve driver 154 configured to control a power supply to a first valve coil of a valve V, a first processor 151 configured to control the first motor driver 153 and the first valve driver 154, a first memory 152 configured to store or memorize programs and data for implementing operations of components included in the first controller 150, and a first regulator 155 configured to provide at least one of the first valve driver 154 and the first processor 151 with first driving power at a preset level.

The second controller 160 may include a second motor driver 163 configured to control a power supply to a second motor coil 420 of the hydraulic pressure generation motor M, a second valve driver 164 configured to control a power supply to a second valve coil of the valve V, a second processor 161 configured to control the second motor driver 163 and the second valve driver 164, a second memory 162 configured to store or memorize programs and data for implementing operations of components included in the second controller 160, and a second regulator 165 configured to provide at least one of the second valve driver 164 and the second processor 161 with second driving power at a preset level. The above-mentioned components are not essential components of the control device 110, and at least some of the above-mentioned components may be excluded.

The first processor 151 and the second processor 161 may be provided as micro control units (not illustrated). The first processor 151 and the second processor 161 may perform preset computation in response to the output signals from the pedal displacement sensor 50 and/or the wheel speed sensor 60. In addition, the first processor 151 and the second processor 161 may identify a braking force (or braking acceleration or fastening force) corresponding to the service brake, the ABS, the TSC, the ESC, and the like based on the executed computation and output a braking control signal, which corresponds to the braking force, to all or some of the first motor driver 153, the second motor driver 163, the first valve driver 154, and the second valve driver 164.

The first memory 152 and the second memory 162 may provide the stored program and data to the first processor 151 and the second processor 161 and memorize temporary data produced during the operations of the first processor 151 and the second processor 161. For example, the first memory 152 and the second memory 162 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The first controller 150 and the second controller 160 may be connected by a first internal communication network CAN1 and transmit and receive signals for identifying states thereof.

In addition, the first controller 150 and the second controller 160 may be connected by a second internal communication network CAN2 and send and receive signals for identifying states thereof.

As described above, the first controller 150 and the second controller 160 are connected by the dualized internal communication networks CAN1 and CAN2, such that the states of the first controller 150 and the second controller 160 may be monitored by a normal internal communication network even though any one internal communication network fails.

The first internal communication network CAN1 and the second internal communication network CAN2 may use various communication methods such as Ethernet, media-oriented system transport (MOST), a universal asynchronous receiver/transmitter (UART), Flexray, a controller area network (CAN), and a local interconnect network (LIN).

The first controller 150 may periodically transmit a status signal to the second controller 160. The second controller 160 may identify a normal operating state of the first controller 150 based on a result of receiving the periodic status signal by the first controller 150.

In case that the first controller 150 does not operate normally, the first controller 150 may not transmit the periodic status signal to the second controller 160. The second controller 160 may identify an abnormal operating state (e.g., damage, error, reset, power cut off, or the like) of the first controller 150 at a predetermined cycle based on a situation in which the first controller 150 does not receive the periodic status signal.

The second controller 160 may output electrical signals, which correspond to the service brake, the EPB, and the like, to first and second electronic parking brakes 181 and 182 based on the result of identifying the abnormal operating state (e.g., damage, error, reset, power cut off, or the like) of the first controller 150.

The pedal displacement sensor 50 may include a first pedal displacement sensor 51 and a second pedal displacement sensor 52 in order to prepare for damage to or an error of an electric system.

The first pedal displacement sensor 51 and the second pedal displacement sensor 52 may each detect a movement of the brake pedal 55 and output the electrical output signals PTS1 and PTS2, which correspond to the movement (e.g., a movement displacement and/or a movement speed) of the brake pedal 55, to the first controller 150 and the second controller 160. For example, the first pedal displacement sensor 51 may be electrically connected to the first controller 150 and the second controller 160 and output a first pedal displacement signal PTS1 and a second pedal displacement signal PTS2 to the first controller 150 and the second controller 160.

The wheel speed sensor 60 may include the plurality of wheel speed sensors 61, 62, 63, and 64 respectively installed in the plurality of wheels 11, 12, 13, and 14. For example, the wheel speed sensor 60 may include the first to fourth wheel speed sensors 61, 62, 63, and 64.

The first to fourth wheel speed sensors 61, 62, 63, and 64 may independently detect the rotational speeds of the first to fourth wheels 11, 12, 13, and 14. In addition, the first to fourth wheel speed sensors 61, 62, 63, and 64 may be electrically connected to the brake system 100 and output the electrical signals WSS1, WSS2, WSS3, and WSS4, which correspond to the rotational speeds of the first to fourth wheels 11, 12, 13, and 14, to the brake controllers 150 and 160.

The first to fourth wheel speed sensors 61, 62, 63, and 64 may output the first to fourth wheel speed signals WSS1, WSS2, WSS3, and WSS4 to multiple channels to prepare for damage to or an error of the electric system.

For example, the first to fourth wheel speed sensors 61, 62, 63, and 64 may output the first to fourth wheel speed signals WSS1, WSS2, WSS3, and WSS4, which correspond to the rotational speeds of the first to fourth wheels 11, 12, 13, and 14, to the first controller 150 and the second controller 160 through a first output channel and a second output channel. The first controller 150 and the second controller 160 may receive, through the first output channel and the second output channel, the first to fourth wheel speed signals WSS1, WSS2, WSS3, and WSS4 outputted from the first to fourth wheel speed sensors 61, 62, 63, and 64.

The first controller 150 and the second controller 160 may identify a communication state (e.g., a normal state or a failure state) based on whether the first to fourth wheel speed signals WSS1, WSS2, WSS3, and WSS4 outputted from the first to fourth wheel speed sensors 61, 62, 63, and 64 are received.

For example, when a communication failure is identified as the first controller 150 cannot receive at least one of the first to fourth wheel speed signals WSS1, WSS2, WSS3, and WSS4 from the first to fourth wheel speed sensors 61, 62, 63, and 64, the first controller 150 may perform the braking control on the hydraulic pressure device 200 by using the wheel speed signal received by the second controller 160.

In addition, when a communication failure is identified as the second controller 160 cannot receive at least one of the first to fourth wheel speed signals WSS1, WSS2, WSS3, and WSS4 from the first to fourth wheel speed sensors 61, 62, 63, and 64, the second controller 160 may perform the braking control on the hydraulic pressure device 200 by using the wheel speed signal received by the first controller 150.

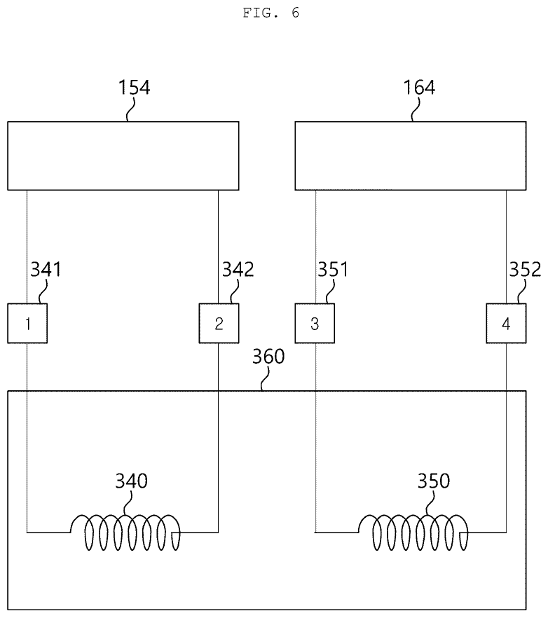

FIG. 4 is a view illustrating a cross-sectional structure of the valve according to the embodiment of the disclosed disclosure. FIG. 5 is a view illustrating a planar structure of the valve according to the embodiment of the disclosed disclosure.

With reference to FIGS. 4 and 5, the valve V according to the embodiment of the disclosed disclosure may be an electronic hydraulic valve operated by the above-mentioned hydraulic pressure device 200 to control a flow of the pressing medium. In this regard, the valve V may broadly include a coil assembly 300 and a valve assembly (not illustrated). In addition, the coil assembly 300 may include a bobbin 320, a first valve coil 340, a second valve coil 350, an insulator 330, a coil casing 360, and a fixing pin 370. The valve V may have a cylindrical shape.

The bobbin 320 may have an insertion hole formed at a center of the valve V so that an armature 310 moves upward or downward.

The first valve coil 340 and the second valve coil 350 are configured to electromagnetically operate the armature 310 and disposed in series by being wound around an outer peripheral surface of the bobbin 320 in one axial direction (e.g., a longitudinal direction of the bobbin 320).

The first valve coil 340 and the second valve coil 350 may each be a single coil or a plurality of coils wound around the bobbin 320 with a preset total number of turns and wound at a preset proportion within the preset total number of turns. For example, when the total number of turns is about 100, the number of turns of each of the a first valve coil 340 and a second valve coil 350 may be 50. However, the present disclosure is not limited thereto. The first valve coil 340 and the second valve coil 350 may be wound with the number of turns at various proportions and electrically independent.

The first valve coil 340 and the second valve coil 350 may be alternately and sequentially wound around the outer peripheral surface of the bobbin 320. For example, the first valve coil 340 may be an N-th coil wound around the bobbin 320, and the second valve coil 350 may be an (N+1)th coil wound around the bobbin 320. In this case, N is a natural number.

Meanwhile, alternatively, the first valve coil 340 and the second valve coil 350 may be separated and wound around concentric circles with different diameters. In this case, a winding diameter of any one of the first valve coil 340 and the second valve coil 350 may be larger than a winding diameter of the other of the first valve coil 340 and the second valve coil 350. That is, any one of the first valve coil 340 and the second valve coil 350 may be wound outward of the other of the first valve coil 340 and the second valve coil 350. In this case, the insulator 330 may be provided between the first valve coil 340 and the second valve coil 350 to implement electrical insulation.

The first valve coil 340 and the second valve coil 350 may be provided as coils having different diameters. Any one of the first valve coil 340 and the second valve coil 350 has a larger diameter than the other of the first valve coil 340 and the second valve coil 350. In this case, any one of the first valve coil 340 and the second valve coil 350 may have a smaller diameter and be wound with a larger number of turns than the other of the first valve coil 340 and the second valve coil 350.

The first valve coil 340 and the second valve coil 350 may be provided as solenoid coils.

The valve V may further include a first valve coil terminal 341 connected to two opposite ends of the first valve coil 340, and a second valve coil terminal 342 connected to two opposite ends of the second valve coil 350. In this case, the two opposite ends of the first valve coil 340 and the two opposite ends of the second valve coil 40 may penetrate the coil casing 360 and protrude upward from the coil casing 360.

The two opposite ends of the first valve coil 340 may be positioned adjacent to each other, and the two opposite ends of the second valve coil 350 may also be positioned adjacent to each other.

A first exposure region between the two opposite ends of the first valve coil 340 and the coil casing 360 and a second exposure region between the two opposite ends of the second valve coil 350 and the coil casing 360 may be provided to be accommodated in separate insulators 33 and 43. In this case, the first exposure region may be a portion where the first valve coil 340 is exposed between the two opposite ends of the first valve coil 340 and the coil casing 360, and the first exposure region may be provided to be accommodated in the separate insulator 330. Like the first valve coil 340, the second exposure region may be a portion where the second valve coil 350 is exposed between the two opposite ends of the second valve coil 350 and the coil casing 360, and the second exposure region may be provided to be accommodated in another separate insulator 43.

The first valve coil terminal 341 and the second valve coil terminal 342 may be disposed symmetrically with respect to the bobbin 10. That is, the first valve coil terminal 341 and the second valve coil terminal 342 may be disposed at positions opposite to each other at about 180 degrees. The first valve coil terminal 341 and the second valve coil terminal 342, which are disposed to be opposite to each other, may easily separate the coils, reduce the occurrence of noise between the terminals, and allow a line connection structure with the first valve driver 154 and the second valve driver 164 to be variously designed. However, the present disclosure is not limited thereto. Arrangement structures with various shapes may be applied.

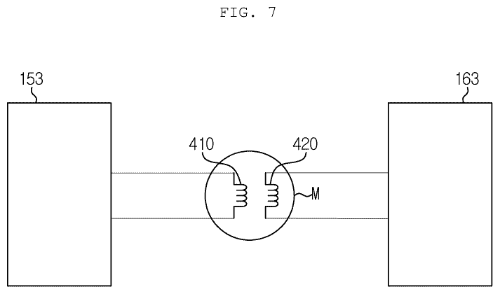

FIG. 6 is a view illustrating a connection relationship between the valve and the valve drivers according to the embodiment of the disclosed disclosure.

With reference further to FIG. 6, first valve coil terminals 341 and 342 may be electrically connected to the first valve driver 154, and second valve coil terminals 351 and 352 may be electrically connected to the second valve driver 164.

The first valve driver 154 and the second valve driver 164 may be respectively and electrically connected to the first valve coil terminals 341 and 342 and the second valve coil terminals 351 and 352 in the valve V and control a power supply to the valve 2 by applying driving power to the first valve coil 340 and the second valve coil 350.

With reference back to FIGS. 4 and 5, the insulator 330 may be provided between the first valve coil 340 and the second valve coil 350 to electrically insulate the first valve coil 340 and the second valve coil 350.

The coil casing 360 may be provided at a predetermined interval from the second valve coil 350 and accommodate the first valve coil 340 and the second valve coil 350.

One end of the fixing pin 370 may be positioned between an outer peripheral surface of the second valve coil 350 and an inner peripheral surface of the coil casing 360. The fixing pin 370 may penetrate the coil casing 360, and the other end of the fixing pin 370 may protrude upward from the coil casing 360. The fixing pin 370 may be a cylindrical shape.

The fixing pin 370 may serve to stably couple the coil assembly 300 and the valve assembly so that the coil assembly 300 and the valve assembly constitute the single valve V.

The valve V may adopt the dual windings and thus provide the redundancy to the coils in the valve in comparison with a valve in the related art equipped with a single winding. Therefore, even in an abnormal situation such as a situation in which any one of the two coils is short-circuited or opened, the valve driver connected to another electrically independent coil may control the valve V, thereby providing stability and reliability to the brake system 100.

With reference back to FIG. 1, the first controller 150 and the second controller 160 may identify the states thereof by means of at least one of the first internal communication network CAN1 and the second internal communication network CAN2.

When the first controller 150 and the second controller 160 identify that the first controller 150 and the second controller 160 are in the normal states based on first operation control, the first processor 151 may control the first motor driver 153 and the first valve driver 154, and the second processor 161 may control the second motor driver 163 and the second valve driver 164, such that cooperative control may be performed.

The first controller 150 and the second controller 160 may provide the plurality of wheel cylinders 31, 32, 33, and 34 with the hydraulic pressure, which satisfies a preset braking force, by means of the cooperative control. The first controller 150 and the second controller 160 may provide the hydraulic pressure to the plurality of wheel cylinders 31, 32, 33, and 34 by means of cooperative control in order to exhibit the braking force that satisfies the driver's braking intention.

In addition, when the first controller 150 and the second controller 160 identify a failure of any one of the first controller 150 and the second controller 160 based on second operation control, the other of the first controller 150 and the second controller 160 may control the first motor driver 153 and the first valve driver 154 or control the second motor driver 163 and the second valve driver 164.

For example, the first controller 150 may identify the operating state (e.g., the normal state or the failure state) of the second controller 160 based on whether the second controller 160 receives a periodic status signal. If the failure of the second controller 160 is identified, the first controller 150 may provide the hydraulic pressure to the plurality of wheel cylinders 31, 32, 33, and 34 by controlling the first motor driver 153 and the first valve driver 154. In this case, the first processor 151 of the first controller 150 may control the hydraulic pressure supplier 230 and the hydraulic controller 240 of the hydraulic pressure device 200 by controlling the first motor driver 153 and the first valve driver 154 electrically independent of the second controller 160.

In addition, the second controller 160 may identify the operating state (e.g., the normal state or the failure state) of the first controller 150 based on whether the first controller 150 receives the periodic status signal. If the failure of the first controller 150 is identified, the second controller 160 may provide the hydraulic pressure to the plurality of wheel cylinders 31, 32, 33, and 34 by controlling the second motor driver 163 and the second valve driver 164. In this case, the second processor 161 of the second controller 160 may control the hydraulic pressure supplier 230 and the hydraulic controller 240 of the hydraulic pressure device 200 by controlling the second motor driver 163 and the second valve driver 164 electrically independent of the first controller 150.

The power supply device 170 may supply power to the control device 110. In this regard, the power supply device 170 may include a first power supplier 171 configured to supply first power BAT1 to the first controller 150, and a second power supplier 172 configured to supply second power BAT2 to the second controller 160.

The first power supplier 171 and the second power supplier 172 may respectively output the first power BAT1 and the second power BAT2 at preset levels. In this case, the first power supplier 171 and the second power supplier 172 may output the first power BAT1 and the second power BAT2 at different levels.

For example, the first power supplier 171 and the second power supplier 172 may respectively include batteries with different conditions. That is, the first power supplier 171 and the second power supplier 172 may supply the first controller 150 and the second controller 160 with the first power BAT1 and the second power BAT2, which are electrically independent, even though the batteries with different types of voltages are used.

If the first power supplier 171 and the second power supplier 172 are electrically connected and supply power, there may occur a loss of power organized as a counter electromotive force based on the occurrence of a voltage difference in accordance with a battery condition in the brake system 100. However, the first power supplier 171 and the second power supplier 172, which independently supply power, do not cause a voltage difference in accordance with the battery condition, which may solve a problem of a loss of power.

FIG. 5 is a view illustrating a connection relationship between the motor driver and the motor according to the embodiment of the disclosed disclosure.

With reference to FIG. 5, the first motor driver 153 and the second motor driver 163 may respectively include inverters configured to convert the first power BAT1 and the second power BAT2 into three-phase power and supply the power to the first motor coil 410 and the second motor coil 420. In this case, the first motor driver 153 and the second motor driver 163 may further respectively include relays (not illustrated) and a plurality of switches (not illustrated). The relays of the first motor driver 153 and the second motor driver 163 may be configured to cut off or allow the supplies of the first power BAT1 and the second power BAT2. The switches of the first motor driver 153 and the second motor driver 163 may be configured to convert the first power BAT1 and the second power BAT2 into three-phase power.

The motor M may adopt the dual windings and thus provide the redundancy to the coils in the motor in comparison with a motor in the related art equipped with a single winding. Therefore, even in an abnormal situation such as a situation in which any one of the two coils is short-circuited or opened, the motor driver connected to another electrically independent coil may control the motor M, thereby providing stability and reliability to the brake system 100.

The brake system according to the embodiment of the disclosed disclosure may perform the normal braking control by controlling the hydraulic pressure device by using the electrically independent the first controller or the second controller even if a part of the brake system fails. Therefore, the brake system may ensure the redundancy capable of coping with the failure of some devices and prevent an increase in costs and an addition of processes due to the addition of other devices.

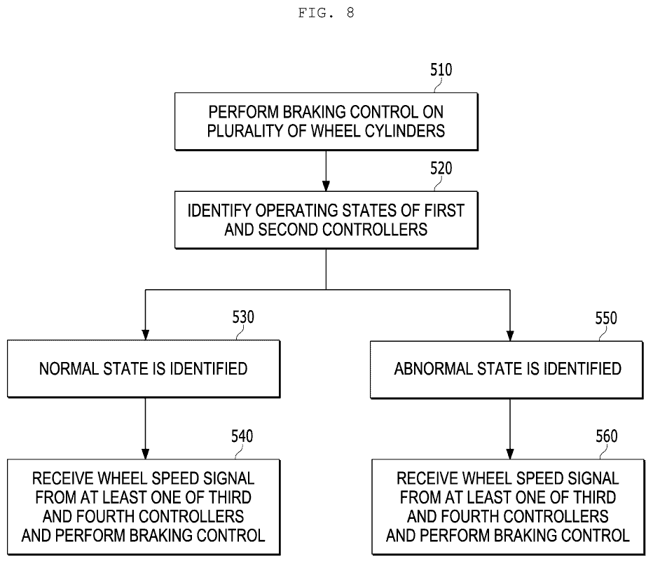

FIG. 7 is a view illustrating a method of controlling the brake system according to the embodiment of the disclosed disclosure.

Hereinafter, a method of controlling the brake system according to the embodiment of the disclosed disclosure will be described.

With reference to FIG. 7, in the method of controlling the brake system according to the embodiment of the disclosed disclosure, the first controller 150 and the second controller 160 may perform the braking control on the plurality of wheel cylinders 31, 32, 33, and 34 based on at least one of the pedal displacement signals PTS1 and PTS2, which correspond to the movement of the brake pedal 55, and the hydraulic pressure generated by the hydraulic pressure device 200 (510).

The first controller 150 and the second controller 160 may control the hydraulic pressure supplier 230 and the hydraulic controller 240 of the hydraulic pressure device 200 configured to supply the hydraulic pressure to the plurality of wheel cylinders 31, 32, 33, and 34.

The first controller 150 and the second controller 160 may identify the states thereof by means of at least one of the first internal communication network CAN1 and the second internal communication network CAN2 (520).

When the result of identifying the states of the first controller 150 and the second controller 160 indicates that the first controller 150 and the second controller 160 are in the normal states (530), the first processor 151 of the first controller 150 may control the first motor driver 153 and the first valve driver 154, and the second processor 161 of the second controller 160 may control the second motor driver 163 and the second valve driver 164, based on the first operation control, such that the cooperative control may be performed (540).

When the result of identifying the states of the first controller 150 and the second controller 160 indicates that any one of the first controller 150 and the second controller 160 is in an abnormal state (550), the other of the first controller 150 and the second controller 160 may control the first motor driver 153 and the first valve driver 154 or control the second motor driver 163 and the second valve driver 164 (560).

For example, when a failure of the second controller 160 is identified, the first processor 151 of the first controller 150 may control the first motor driver 153 and the first valve driver 154, and the first valve driver 154 may control the power supply to the first valve coil 340 of the valve V, based on the second operation control.

In addition, when a failure of the first controller 150 is identified, the second processor 161 of the second controller 160 may control the second motor driver 163 and the second valve driver 164, and the second valve driver 164 may control the power supply to the second valve coil 350 of the valve V, based on the second operation control.

The first power supplier 171 and the second power supplier 172 may supply the first controller 150 and the second controller 160 with the first power BAT1 and the second power BAT2 at the preset levels. In this case, the first power supplier 171 and the second power supplier 172 may output the first power BAT1 and the second power BAT2 at different levels.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

While the disclosed embodiments have been described above with reference to the accompanying drawings, the embodiments are just illustrative and not intended to limit the present specification. It can be appreciated that various modifications and alterations, which are not described above, may be made to the present embodiment by those skilled in the art to which the present specification pertains without departing from the intrinsic features of the present disclosure. The respective constituent elements specifically described in the embodiments may be modified and then carried out. Further, it should be interpreted that the differences related to the modifications and applications are included in the scope of the present specification defined by the appended claims.

What is claimed is:

1. A brake system comprising:
a hydraulic pressure supplier comprising a motor configured to pressurize a pressing medium, wherein the hydraulic pressure supplier is configured to generate hydraulic pressure;
a hydraulic controller provided between the hydraulic pressure supplier and a plurality of wheel cylinders respectively provided in wheels of a vehicle, wherein the hydraulic controller comprises one or more valves and is configured to transmit the hydraulic pressure, which is generated by the hydraulic pressure supplier, to the plurality of wheel cylinders; and
a control device configured to control at least one of the hydraulic pressure supplier and the hydraulic controller, based on at least one of the hydraulic pressure and a pedal displacement signal corresponding to a movement of a brake pedal,
wherein the motor comprises a first motor coil and a second motor coil,
wherein the valve comprises a first valve coil and a second valve coil,
wherein the control device comprises a first controller and a second controller configured to perform a first operation control on the hydraulic pressure supplier and the hydraulic controller in a normal state and perform a second operation control on the hydraulic pressure supplier and the hydraulic controller in an abnormal state and
wherein the first controller and the second controller are electrically isolated from each other and are configured to perform either the first operation control or the second operation control on the hydraulic pressure supplier and the hydraulic controller.

2. The brake system of claim 1, wherein the first controller comprises:
a first motor driver configured to control a power supply to the first motor coil of the motor;
a first valve driver configured to control a power supply to the first valve coil of the valve;
a first processor configured to control the first motor driver and the first valve driver; and
a first regulator configured to provide at least one of the first valve driver and the first processor with first driving power at a preset level and
wherein the second controller comprises:
a second motor driver configured to control a power supply to the second motor coil of the motor;
a second valve driver configured to control a power supply to the second valve coil of the valve;
a second processor configured to control the second motor driver and the second valve driver; and
a second regulator configured to provide at least one of the second valve driver and the second processor with second driving power at a preset level.

3. The brake system of claim 2, wherein the first valve coil and the second valve coil of the valve are disposed in series by being wound around an outer peripheral surface of a bobbin in one axial direction.

4. The brake system of claim 3, wherein the first valve coil and the second valve coil are alternately and sequentially wound around the outer peripheral surface of the bobbin.

5. The brake system of claim 3, wherein the valve further comprises:
a first valve coil terminal connected to two opposite ends of the first valve coil; and
a second valve coil terminal connected to two opposite ends of the second valve coil.

6. The brake system of claim 5, wherein the first valve coil terminal and the second valve coil terminal are disposed symmetrically with respect to the bobbin.

7. The brake system of claim 6, wherein the two opposite ends of the first valve coil and the two opposite ends of the second valve coil penetrate an upper portion of a coil casing configured to accommodate the first valve coil and the second valve coil and are connected to the first valve coil terminal and the second valve coil terminal provided on the upper portion of the coil casing.

8. The brake system of claim 7, wherein a first exposure region between the two opposite ends of the first valve coil and the coil casing and a second exposure region between the two opposite ends of the second valve coil and the coil casing are provided to be accommodated in a separate insulator.

9. The brake system of claim 5, wherein the first valve coil terminal is configured to be electrically connected to the first valve driver, and the second valve coil terminal is configured to be electrically connected to the second valve driver.

10. The brake system of claim 2, wherein the first valve coil and the second valve coil are provided as solenoid coils.

11. The brake system of claim 2, further comprising:
an internal communication network configured to connect the first controller and the second controller,
wherein the first controller and the second controller identify states thereof by means of the internal communication network.

12. The brake system of claim 11, wherein the first operation control performs cooperative control by allowing the first processor to control the first motor driver and the first valve driver and allowing the second processor to control the second motor driver and the second valve driver when the first controller and the second controller are identified as being in the normal states.

13. The brake system of claim 11, wherein when a failure of any one of the first controller and the second controller is identified, the second operation control allows the other of the first controller and the second controller to control a power supply to the first valve coil based on control of the first valve driver or control a power supply to the second valve coil based on control of the second valve driver.

14. The brake system of claim 1, further comprising:
a power supply device configured to supply power to the control device,
wherein the power supply device comprises:
a first power supplier configured to supply first power to the first controller; and
a second power supplier configured to supply second power to the second controller.

15. The brake system of claim 14, wherein the first power supplier and the second power supplier respectively output the first power and the second power at different levels.

16. A method of controlling a brake system, which comprises a hydraulic pressure supplier comprising a motor comprising a first motor coil and a second motor coil and configured to generate hydraulic pressure, a hydraulic controller comprising a valve comprising a first valve coil and a second valve coil and configured to transmit the hydraulic pressure, which is generated by the hydraulic pressure supplier, to a plurality of wheel cylinders, and a first controller and a second controller isolated electrically and configured to perform a first operation control or a second operation control on the hydraulic pressure supplier and the hydraulic controller, the method comprising:
performing, by the first controller and the second controller, the first operation control on the hydraulic pressure supplier and the hydraulic controller in a normal state and performing the second operation control on the hydraulic pressure supplier and the hydraulic controller in an abnormal state based on at least one of the hydraulic pressure and a pedal displacement signal corresponding to a movement of a brake pedal.

17. The method of claim 16, further comprising:
identifying states of the first controller and the second controller; and
performing cooperative control by allowing a first processor of the first controller to control a first motor driver and a first valve driver and allowing a second processor of the second controller to control a second motor driver and a second valve driver based on the first operation control when the first controller and the second controller are identified as being in the normal states.

18. The method of claim 16, further comprising:
identifying states of the first controller and the second controller; and
controlling, by a first processor of the first controller, a first motor driver and a first valve driver and controlling, by the first valve driver, a power supply to a first valve coil of the valve based on the second operation control when a failure of the second controller is identified.

19. The method of claim 18, further comprising:
controlling, by a second processor of the second controller, a second motor driver and a second valve driver and controlling, by the second valve driver, a power supply to a second valve coil of the valve based on the second operation control when a failure of the first controller is identified.

20. The method of claim 16, wherein the brake system further comprises:
a first power supplier configured to provide first power to the first controller; and
a second power supplier configured to provide second power to the second controller and
wherein the method further comprises providing, by the first power supplier and the second power supplier, the first controller and the second controller with the first power and the second power at different levels.
